(19) United States
(12) Patent Application Publication
(10) Pub. No.: US 2011/0218914 A1
(43) Pub. Date: Sep. 8, 2011

(54) CLOSED LOOP STORED VALUE INSTRUMENT BROKERAGE SYSTEM, METHOD AND COMPUTER PROGRAM PRODUCT

(76) Inventors: Marc Rochman, North Miami Beach, FL (US); Hillel Krajzman, Mountain View, CA (US)

(21) Appl. No.: 12/717,950

(22) Filed: Mar. 5, 2010

(51) Int. Cl. G06Q 40/00

(52) U.S. Cl. 705/44; 705/39

(57) ABSTRACT

Embodiments of the present invention provide a method, system and computer program product for a closed loop stored value instrument brokerage. In an embodiment of the invention, a method for brokering a closed loop stored value instrument can include receiving a request in brokerage logic executing in memory by at least one processor of a computer. The request can include a request to broker a payment of a sale price for an item purchased from a selling merchant with a closed loop stored value instrument issued by a separate originating merchant. In response to the receipt of the request, the originating merchant can be directed to debit the closed loop stored value instrument in an amount equivalent to the sale price. Thereafter, payment to the selling merchant can be transferred in an amount less than the sale price.

### BACKGROUND OF THE INVENTION

1. Field of the Invention

The present invention relates to stored value instruments and more particularly to closed loop stored value instruments.

2. Description of the Related Art

Stored value instruments generically refer to pre-paid accounts reflecting an amount of value stored in advance of a purchase. The value can be currency issued by a governmental entity or an artificial currency not sanctioned by any governmental entity. Early forms of the stored value instrument included gift certificates and credits issued by a purveyor of goods or services. The use of the gift certificate has not varied for several decades. Essentially, the holder of the gift certificate applies the face value of the gift certificate towards the purchase of a product or service offered by the issuer of the gift certificate. Some gift certificate issuers will convert any remaining, unused portion of the gift certificate into legal tender, while others require forfeiture of any remaining, unused portion of the gift certificate thus forcing the bearer of the gift certificate to purchase a product or service whose value exceeds that of the gift certificate.

The gift card represents an advanced form of the stored value instrument. A gift card, like a gift certificate, includes a value, however, an electronic account linked to the gift card can track an amount of value remaining for use by the bearer of the gift card. Even more advanced forms of the gift card permit “recharging” so that an amount of value remaining for use by the bearer of the gift card can be increased through a pre-payment transaction associated with the gift card. Yet further, some gift cards today are not “cards” at all, but more electronic representations of a stored value account. These e-gift cards can be transmitted electronically as attachments to messages, can be embedded as part of a message such as an e-mail, instant message or text message, or downloaded from a Web page, to name only a few well-known modalities.

Stored value instruments are classified as either closed loop stored value instruments, or open loop stored value instruments. A closed loop stored value instrument enjoys a direct correspondence to a purveyor of goods or services (and potentially a legally related family of purveyors of goods and services such as subsidiaries of one another, or sibling entities of a parent company, or contractually linked companies such as those entities bound to one another through joint marketing agreements). In contrast, an open loop stored value instrument has no direct correspondence with any purveyor of goods and services, but to an issuing authority, such as a bank. Most credit card issuing agencies issue gift cards redeemable through an existing credit card/debit card network so that any purveyor of goods or services can access stored value in the stored value instrument issued by a particular authority so long as the purveyor of goods or services also can access credit or debit accounts supported by the particular authority.

Notwithstanding the convenience afforded by stored value instruments, open loop stored value instruments can be costly to process for the merchant accepting payment by the open loop stored value instrument just in the same way the merchant incurs transaction fees associated with the acceptance of payment by way of a debit or credit card. Thus, accepting a closed loop stored value instrument issued by the merchant is preferable from the perspective of the merchant as the cost of transacting payment by the closed loop stored value instrument can be minimized. Yet, from the perspective of the consumer, a closed loop stored value instrument can be limiting in that the closed loop stored value instrument only can be redeemed for products or services provided by the issuing merchant.

### BRIEF SUMMARY OF THE INVENTION

Embodiments of the present invention address deficiencies of the art in respect to processing closed loop stored value instrument transactions and provide a novel and non-obvious method, system and computer program product for a closed loop stored value instrument brokerage. In an embodiment of the invention, a method for brokering a closed loop stored value instrument can include receiving a request in brokerage logic executing in memory by at least one processor of a computer. The request can include a request to broker a payment of a sale price for an item purchased from a selling merchant with a closed loop stored value instrument issued by a separate originating merchant. In response to the receipt of the request, the originating merchant can be directed to debit the closed loop stored value instrument in an amount equivalent to the sale price. Finally, payment to the selling merchant can be transferred in an amount less than the sale price.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for brokering a closed loop stored value instrument;

FIG. 2 is a schematic illustration of a closed loop stored value instrument brokerage data processing system; and,

FIG. 3 is a flow chart illustrating a process for brokering a closed loop stored value instrument in the system of FIG. 1.

### DETAILED DESCRIPTION OF THE INVENTION

Embodiments of the invention provide for a method, system and computer program product for a closed loop stored value instrument brokerage. In accordance with an embodiment of the invention, a request can be received to pay a first merchant with value from a closed loop stored value instrument issued in connection with a second merchant unrelated to the first merchant. In response to the request, the value can be deducted from an account associated with the closed loop stored value instrument and a transaction can be recorded from the second merchant to the first merchant for a substantial portion of the value. A remaining portion of the value can be allocated as a fee for the transaction. In this way, the value associated with the closed loop stored value instrument issued by the second merchant can be used to purchase goods or services from the first merchant even though the first and second merchants are not related.

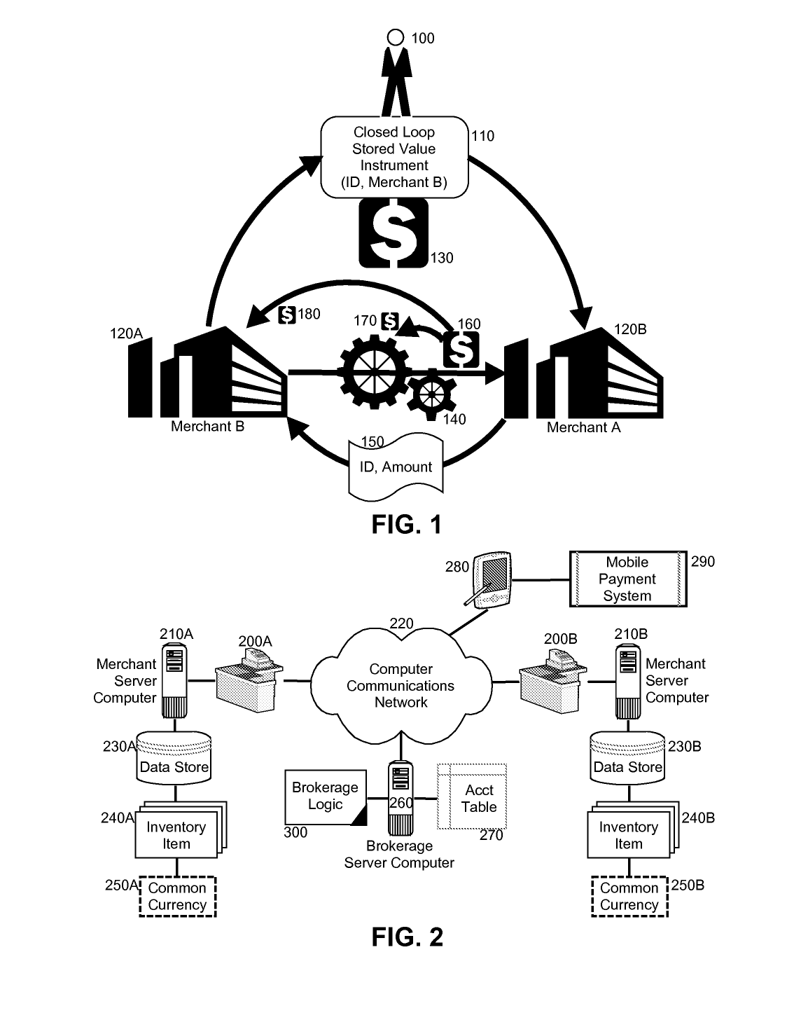

In illustration, FIG. 1 pictorially shows a process for brokering a closed loop stored value instrument. As shown in FIG. 1, an originating merchant 120A can issue to consumer 100 a closed loop stored value instrument 110 associated with a stored value 130. The consumer 100, in turn, can use the closed loop stored value instrument 110 to purchase an item such as a product or service from a selling merchant 120B. The selling merchant 120B, legally unrelated to the originating merchant 120A, can determine the originating merchant 120B of the closed loop stored value instrument 110 and an identifier for the closed loop stored value instrument 110. Thereafter, brokerage logic 140 can be provided the identity of the closed loop stored value instrument 110 and the originating merchant 120A along with an amount to be consumed from the closed loop stored value instrument 110 as payment for the purchase.

The brokerage logic 140, that can be included as part of a point of sale system for either or both merchants 120A, 120B, or as part of a third party payment processing system, can direct the originating merchant 120A to deduct the amount from the closed loop stored value instrument 110. The brokerage logic 140 further can compute one or more transaction fees 170, 180 in consideration for the transaction of facilitating the payment to the selling merchant 120B with a closed loop stored value instrument 110 issued by the originating merchant 120A. The transaction fees 170, 180 can include either or both of a transaction fee 170 payable to the originating merchant 120A, and also a transaction fee 180 payable to a third party payment processing system acting as a brokerage for the closed loop stored value instrument 110, to the extent applicable. Subsequently, a payment transaction 160 can be directed to the selling merchant 120B accounting for the amount of the sale of the item less either or both of the transaction fees 170, 180.

In one embodiment of the invention, the process described in connection with FIG. 1 can be implemented in a data processing system with a third party payment processor acting as a mediator to a brokerage transaction between different merchants. In this regard, FIG. 2 schematically shows a closed loop stored value instrument brokerage data processing system including multiple different merchant server computers 210A, 210B (with at least one processor and memory) each coupled to a corresponding point of sale system 200A, 200B. Each point of sale system 200A, 200B can be communicatively linked to a brokerage server computer 260 over computer communications network 220, for example the global Internet. Each merchant server computer 210A, 210B also can include a data store 230B such as a database managed by a database management system in which inventory items 240B and corresponding inventory item information such as quantity on hand, list price, wholesale price, etc. can be stored.

The brokerage server computer 260 (also with at least one processor and memory), can include an accounts table 270 of different merchants and different closed loop stored value instruments corresponding to different merchants. The brokerage server computer 260 also can include brokerage logic 300 reduced in a computer readable storage medium to include computer usable program code enabled upon execution by the processor of the brokerage server computer 260 to mediate payment for a selected item or items purchased from a selling merchant through one of the point of sale systems 200A, 200B with a closed loop stored value instrument issued by a different, unrelated originating merchant.

For example, to effect payment to a selling merchant for a selected product through the point of sale system 200A with a closed loop stored value instrument issued by an originating merchant associated with point of sale system 200B, the amount of the sale and the identification of the closed loop stored value instrument can be provided over the computer communications network 220 to the brokerage logic 300. The brokerage logic 300 in turn can direct the debiting by the originating merchant of the closed loop stored value instrument according to the amount. Yet further, the brokerage logic 300 can compute one or more transaction fees for having brokered the payment transaction and an amount to be transferred from the originating merchant to the selling merchant can be determined accounting for the transaction fees. Finally, the brokerage logic 300 can receive payment from the originating merchant and can provide payment to the selling merchant over the computer communications network 220.

In one aspect of the embodiment, the direction of debiting the closed loop stored value instrument can be effectuated by screen scraping a Web interface to the point of sale system 210B of the originating merchant. In another aspect of the embodiment, the direction of debiting the closed loop stored value instrument can be effectuated by accessing a published application programming interface (API) to the point of sale system 210B of the originating merchant. In yet another aspect of the embodiment, the direction of debiting the closed loop stored value instrument can be effectuated by directing the purchase from the originating merchant of a proxy item, such as a virtualized common currency 250B.

For instance, a virtualized common currency 250B can be established by the brokerage logic 300 and a wholesale price and retail price can be associated with the virtualized common currency 250B. The difference between the wholesale and retail price of the virtualized common currency 250B can reflect a per unit transaction fee owing to the originating merchant when a closed loop stored value instrument issued by the originating merchant is used to purchase items from a different merchant. Consequently, directing the debiting of the closed loop stored value instrument by an originating merchant can occur by purchasing a requisite quantity of common currency 250B equivalent to the amount to be debited from the closed loop stored value instrument. Likewise, directing the transfer of payment (less a transaction fee) from the originating merchant to the selling merchant can result from directing the purchase by the originating merchant of the same quantity of common currency 250B at the wholesale price of the common currency 250B and the transfer of the payment to the selling merchant less any addition transaction fees owing to the third party payment processor.

In an additional aspect of the embodiment, a pervasive device 280 such as a smart phone or personal digital assistant (or even a personal computer) can be operated by a consumer to pay for purchases with a closed loop stored value instrument. In this regard, a mobile payment client 290 as computer usable program code stored in a computer readable storage medium, can execute in memory by at least one processor of the pervasive device 280 to provide a user interface through which a closed loop stored value instrument can be identified and a selling merchant also can be identified along with a purchase amount. The mobile payment client 290 thus can route the collected payment information to the brokerage logic 300 over the computer communications network 220 so as to act as a mobile payment system.

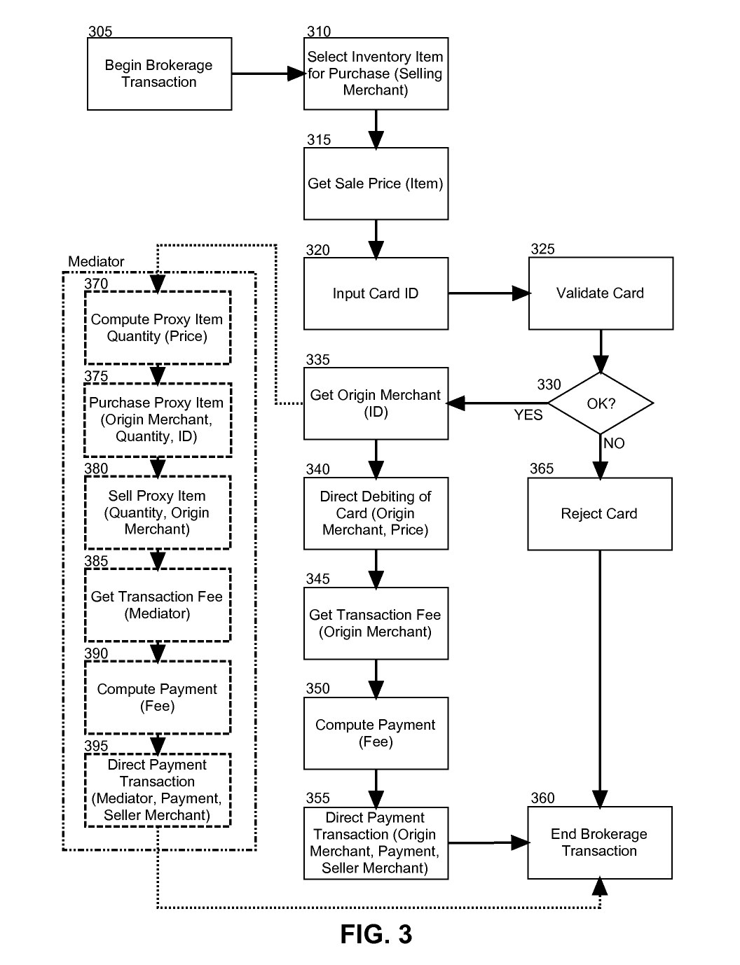

In even yet further illustration of the process performed in the data processing system of FIG. 1, FIG. 3 is a flow chart illustrating a process for brokering a closed loop stored value instrument in the system of FIG. 1. Beginning in block 305, a brokerage transaction can commence in brokering payment in an amount for an item purchased from a selling merchant using a closed loop stored value instrument issued by an unrelated, different originating merchant. In block 310, the item to be purchased can be selected and a sales price amount can be determined for the item (or items). In block 320, identifying information for the closed loop stored value instrument can be retrieved and in block 325, the closed loop stored value instrument can be validated. Specifically, the validity of the closed loop stored value instrument can be determined, and any restrictions on the use of the closed loop stored value instrument can be determined. For example, only certain ranges of identification numbers of a closed loop stored value instrument may be permitted for processing, or only closed loop stored value instruments originating from certain originating merchants may be permitted.

In decision block 330 it can be determined whether or not the closed loop stored value instrument has been validated. If not, in block 365 the transaction can be rejected and the transaction can conclude in block 360. Otherwise, in block 335, an originating merchant issuing the closed loop stored value instrument in block 335 can be identified and in block 340 the originating merchant can be directed to debit the closed loop stored value instrument in an amount equivalent to the sales price amount. Further, in block 345 a transaction fee can be computed for the brokerage transaction and, consequent, in block 350 a payment owing to the selling merchant can be computed. As such, in block 355 a payment transaction accounting for the payment can be directed for payment to the selling merchant and in block 360, the brokerage transaction can end.

Optionally, a proxy item such as a common currency can be used to effectuate the debiting of the closed loop stored value instrument and the direction of the payment transaction to the selling merchant. As reflected in the optional branch of FIG. 3, beginning in block 370 a quantity of proxy items necessary to equate to the sales price can be computed by brokerage logic of a mediator. In block 375, the computed quantity of proxy items can be purchased from the originating merchant using the closed loop stored value instrument corresponding to the previously determined identifying information. In block 380, a corresponding sale to the originating merchant of the same quantity of proxy items (but at a wholesale price for the proxy items) can be directed, the difference between the purchase price of the quantity of proxy items and the wholesale price of the quantity of proxy items reflecting a transaction fee payable to the originating merchant. Additionally, in block 385 a transaction fee owing to the mediator can be determined. Thereafter, in block 390 a final payment owing to the selling merchant can be computed accounting for the transaction fees and in block 395 the payment received from the originating merchant as payment for the quantity of proxy items less the transaction fee paid to the mediator can be provided to the selling merchant. In this way, the mediator will have brokered the use of the closed loop stored value instrument issued by the originating merchant in purchasing items from a legally unrelated and separate selling merchant.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for brokering a closed loop stored value instrument, the method comprising:
receiving in brokerage logic executing in memory by at least one processor of a computer, a request to broker a payment of a sale price for an item purchased from a selling merchant with a closed loop stored value instrument issued by a separate originating merchant;
directing the originating merchant, in response to the receipt of the request, to debit the closed loop stored value instrument in an amount equivalent to the sale price; and,
transferring payment to the selling merchant in an amount less than the sale price.

2. The method of claim 1, wherein receiving in brokerage logic executing in memory by at least one processor of a computer, a request to broker a payment of a sale price for an item purchased from a selling merchant with a closed loop stored value instrument issued by a separate originating merchant, comprises:
receiving in brokerage logic executing in memory by at least one processor of a computer, from a mobile payment client executing in a pervasive device coupled to the computer from over a computer communications network, a request to broker a payment of a sale price for an item purchased from a selling merchant with a closed loop stored value instrument issued by a separate originating merchant.

3. The method of claim 1, wherein directing the originating merchant, in response to the receipt of the request, to debit the closed loop stored value instrument in an amount equivalent to the sale price comprises:
validating the closed loop stored value instrument according to at least one validation rule; and,
responsive to validating the closed loop stored value instrument, directing the originating merchant, in response to the receipt of the request, to debit the closed loop stored value instrument in an amount equivalent to the sale price.

4. The method of claim 1, wherein directing the originating merchant, in response to the receipt of the request, to debit the closed loop stored value instrument in an amount equivalent to the sale price, comprises in response to the receipt of the request:
computing a quantity of proxy items multiplied by a purchase price to equate to the sale price;
purchasing the computed quantity of proxy items from the originating merchant at the purchase price; and,
selling the computed quantity of proxy items to the originating merchant at a wholesale price and receiving payment therefor.

5. The method of claim 4, wherein transferring the received payment to the selling merchant comprises transferring the received payment to the selling merchant less a transaction fee.

6. The method of claim 4, wherein the proxy items are units of virtualized common currency.

7. A computer program product comprising a computer usable storage medium embodying computer usable program code for brokering a closed loop stored value instrument, the computer program product comprising:
computer usable program code for receiving in brokerage logic executing in memory by at least one processor of a computer, a request to broker a payment of a sale price for an item purchased from a selling merchant with a closed loop stored value instrument issued by a separate originating merchant; and,
computer usable program code for directing the originating merchant, in response to the receipt of the request, to debit the closed loop stored value instrument in an amount equivalent to the sale price; and,
transferring payment to the selling merchant in an amount less than the sale price.

8. The computer program product of claim 7, wherein the computer usable program code for receiving in brokerage logic executing in memory by at least one processor of a computer, a request to broker a payment of a sale price for an item purchased from a selling merchant with a closed loop stored value instrument issued by a separate originating merchant, comprises:
computer usable program code for receiving in brokerage logic executing in memory by at least one processor of a computer, from a mobile payment client executing in a pervasive device coupled to the computer from over a computer communications network, a request to broker a payment of a sale price for an item purchased from a selling merchant with a closed loop stored value instrument issued by a separate originating merchant.

9. The computer program product of claim 7, wherein the computer usable program code for directing the originating merchant, in response to the receipt of the request, to debit the closed loop stored value instrument in an amount equivalent to the sale price, comprises:
computer usable program code for validating the closed loop stored value instrument according to at least one validation rule; and,
computer usable program code for directing the originating merchant in response to validating the closed loop stored value instrument, and also in response to the receipt of the request, to debit the closed loop stored value instrument in an amount equivalent to the sale price.

10. The computer program product of claim 7, wherein the computer usable program code for directing the originating merchant, in response to the receipt of the request, to debit the closed loop stored value instrument in an amount equivalent to the sale price, comprises in response to the receipt of the request:
computer usable program code for computing a quantity of proxy items multiplied by a purchase price to equate to the sale price;
computer usable program code for purchasing the computed quantity of proxy items from the originating merchant at the purchase price; and,
computer usable program code for selling the computed quantity of proxy items to the originating merchant at a wholesale price and receiving payment therefor.

11. The computer program product of claim 10, wherein the computer usable program code for transferring the received payment to the selling merchant comprises computer usable program code for transferring the received payment to the selling merchant less a transaction fee.

12. The computer program product of claim 10, wherein the proxy items are units of virtualized common currency.
